(19) United States
(12) Patent Application Publication
(10) Pub. No.: US 2004/0243500 A1
(43) Pub. Date: Dec. 2, 2004

(54) Sales supporting method, program, and recording medium

(75) Inventors: Ichiro Koyama, Kawasaki (JP); Wataru Igarashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/885,711

(22) Filed: Jul. 8, 2004

Related U.S. Application Data
(63) Continuation of application No. PCT/JP02/03117, filed on Mar. 28, 2002.

(51) Int. Cl. G06F 17/60

(52) U.S. Cl. 705/36; 705/37

(57) ABSTRACT

A method for supporting sales of a commodity to a customer is disclosed. The method includes the steps of a) managing desired deficient commodity information including information of a deficient commodity desired by the customer in correspondence with a first discount rate of the deficient commodity and identification information of the customer, and b) discounting the desired deficient commodity based on the first discount rate in a case where the customer purchases the desired deficient commodity.

### BACKGROUND OF THE INVENTION

1. Field of the Invention

The present invention generally relates to a sales supporting method for supporting sales, for example, by discounting a commodity purchased as an alternative for another commodity, in a case where the other commodity is out of stock or not sold at all. Further, the present invention relates to a program for enabling a computer to execute the procedures of the sales supporting method, and a recording medium containing the program.

2. Description of the Related Art

Conventionally, in a case where there are too many leftover commodities, it is possible that the period for selling the leftover commodities may expire or that out of date commodities may not be purchased, thereby causing a store selling the commodities to suffer sales losses. Accordingly, the store orders commodities and adjusts its stock of commodities so that leftover commodities can be as few as possible.

Nevertheless, since the store aims to adjust its stock without having too many leftover commodities, there may be a case where a commodity desired by a customer is out of stock.

Furthermore, there may be a case where the commodity desired by the customer may not be sold at the store in the first place. In such a case where the store lacks the commodity, the customer may go to another store for purchasing the commodity. Accordingly, the store with such lack of commodities eventually will lose its customers. This results in loss of opportunities to sell the commodities and to the reduction of profit.

In a case where there is such a lack of commodities, it is possible for the customer to order the commodity and wait for the next arrival of the commodity. However, for the customer, if there is no benefit in waiting for the arrival of the commodity, the customer may lose his/her desire to purchase the commodity at the store.

### SUMMARY OF THE INVENTION

It is a general object of the present invention to provide a sales supporting method, a program, and a recording medium that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a sales supporting method and a program particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a method for supporting sales of a commodity to a customer, the method including the steps of: a) managing desired deficient commodity information including information of a deficient commodity desired by the customer in correspondence with a first discount rate of the deficient commodity and identification information of the customer; and b) discounting the desired deficient commodity based on the first discount rate in a case where the customer purchases the desired deficient commodity.

According to an embodiment of the present invention, the sales supporting method further includes a step of: c) managing alternative commodity information including information of an alternative commodity corresponding to a prescribed commodity in correspondence with a second discount rate of the alternative commodity.

According to an embodiment of the present invention, the sales supporting method further includes a step of: d) discounting the alternative commodity based on the second discount rate in a case where the customer purchases the alternative commodity.

According to an embodiment of the present invention, the sales supporting method further includes a step of: e) outputting a receipt indicative of discount results according to at least one of the first discount rate and the second discount rate.

According to an embodiment of the present invention, the sales supporting method further includes a step of: f) managing the at least one of the first discount rate and the second discount rate when discounting the commodity purchased by the customer.

According to an embodiment of the present invention, the sales supporting method further includes a step of: g) deleting the desired deficient commodity information and the alternative commodity information.

According to an embodiment of the present invention, the sales supporting method further includes a step of: h) displaying the desired deficient commodity information, the identification information, and the sales information.

Furthermore, the present invention provides a program for enabling a computer to execute a sales supporting method, the program including the functions of: a) managing desired deficient commodity information including information of a deficient commodity desired by the customer in correspondence with a first discount rate of the deficient commodity and identification information of a customer; and b) discounting the desired deficient commodity based on the first discount rate in a case where the customer purchases the desired deficient commodity.

Furthermore, the present invention provides a recording medium stored with a program for enabling a computer to execute the sales supporting method, the recording medium including a program according to an embodiment of the present invention.

Other objects and further features of the present invention will be apparent from the following detailed description when read in conjunction with the accompanying drawings.

### BRIEF DESCRIPTION OF THE DRAWINGS

FIG. 1 is a schematic diagram showing an exemplary configuration of a sales supporting method according to an embodiment of the present invention;

FIGS. 2A and 2B contain a flowchart showing procedures of the sales supporting method according to an embodiment of the present invention;

FIG. 3 is another flowchart showing procedures of the sales supporting method according to an embodiment of the present invention;

FIG. 4 is a schematic diagram showing a table stored in a deficient commodity/purchased commodity information DB according to an embodiment of the present invention;

FIG. 5 is a schematic diagram showing a table stored in an alternative commodity information DB;

FIG. 6 is a schematic diagram showing a table stored in a deficient commodity information DB;

FIG. 7 is a schematic diagram showing a table stored in a sales information DB;

FIG. 8 is a diagram showing an example of a display for explaining a sales supporting method according to an embodiment of the present invention;

FIG. 9A is a schematic diagram showing a receipt output by a sales supporting method according to an embodiment of the present invention; and

FIG. 9B is a schematic diagram showing a receipt output by a sales supporting method according to an embodiment of the present invention.

### DESCRIPTION OF THE PREFERRED EMBODIMENTS

In the following, embodiments of the present invention are described with reference to the accompanying drawings.

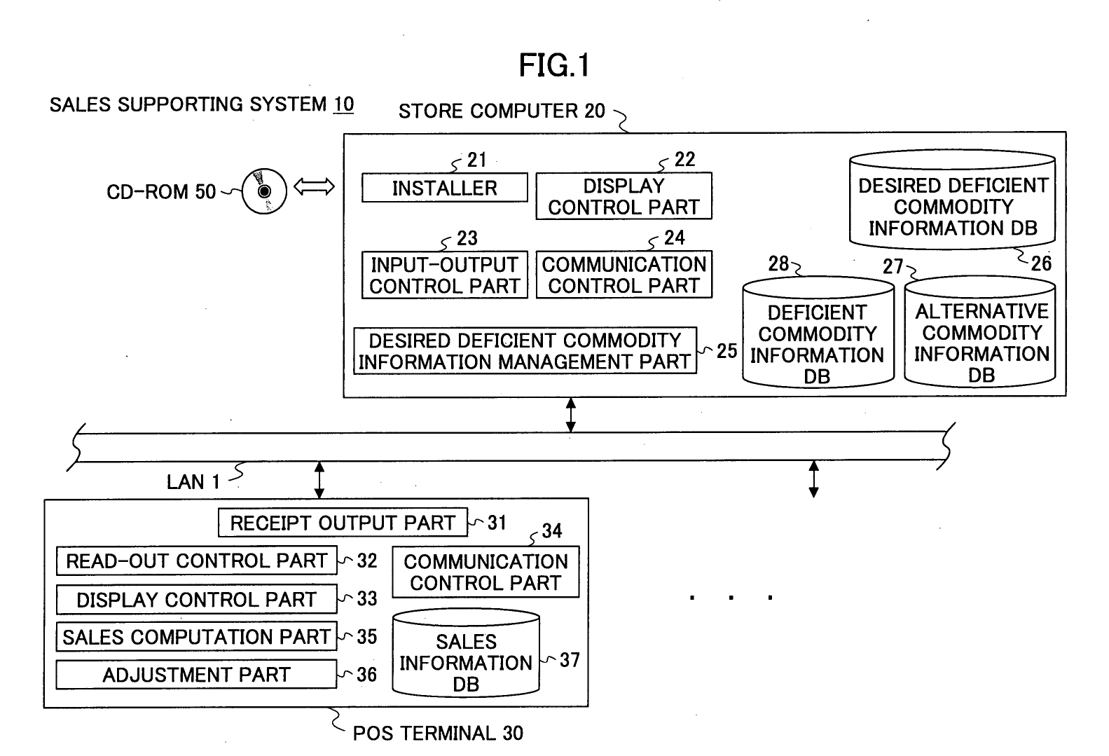

FIG. 1 is a schematic diagram showing an exemplary configuration of a system of the sales supporting method according to an embodiment of the present invention. In FIG. 1, a sales supporting system 10 of the sales supporting method is a system including a store computer 20 provided to a store and a plurality of POS (Point Of Sale) terminals 30.

The store computer 20 mainly includes, for example, an installer 21 for installing a program for executing sales supporting procedures, a display control part 22 for controlling the display of data, an input-output control part 23 for controlling input and output of data, a communication control part 24 for controlling data communications, a desired deficient commodity information management part 25 for executing various procedures such as registration, deletion of desired deficient commodity information based on information such as information from the POS terminals 30, a desired deficient commodity information DB (database) 26 for storing desired deficient commodity information, an alternative commodity information DB (database) 27 for storing alternative commodity information in correspondence with deficient commodity information, and a deficient commodity information DB (database) 28 for storing the deficient commodity information.

The display control part 22, including a display unit such as a display, controls (processes) display data and displays the data on the display unit. The input-output control part 23 controls an input unit (e.g., mouse, keyboard) and an output unit (e.g., printer) for controlling input and output of data. The communication control part 24 is a process part for controlling data communications via a LAN 1, and includes a communication unit for connecting to the LAN 1. The installer 21 reads out a program for executing the sales supporting method according to an embodiment of the present invention from a CD-ROM 50, and installs the read out program in a secondary storage apparatus or the like. When a process for executing the sales supporting method is activated, the CPU begins the process in accordance with the program installed in the secondary storage apparatus. It is to be noted that the medium for storing the program is not to be limited to the CD-ROM 50. Other computer readable media may be alternatively employed.

The desired deficient commodity information management part 25 of the store computer 20 serves to register and/or delete desired deficient commodity information (e.g. customer codes, commodity codes obtained from the POS terminals 30) in and/or from the desired deficient commodity information DB 26. In addition, the desired deficient commodity information management part 25, in response to a request from the POS terminal 30, transmits information (e.g. desired deficient commodity information and/or alternative commodity information stored beforehand in the alternative commodity information DB 27) to the POS terminal 30.

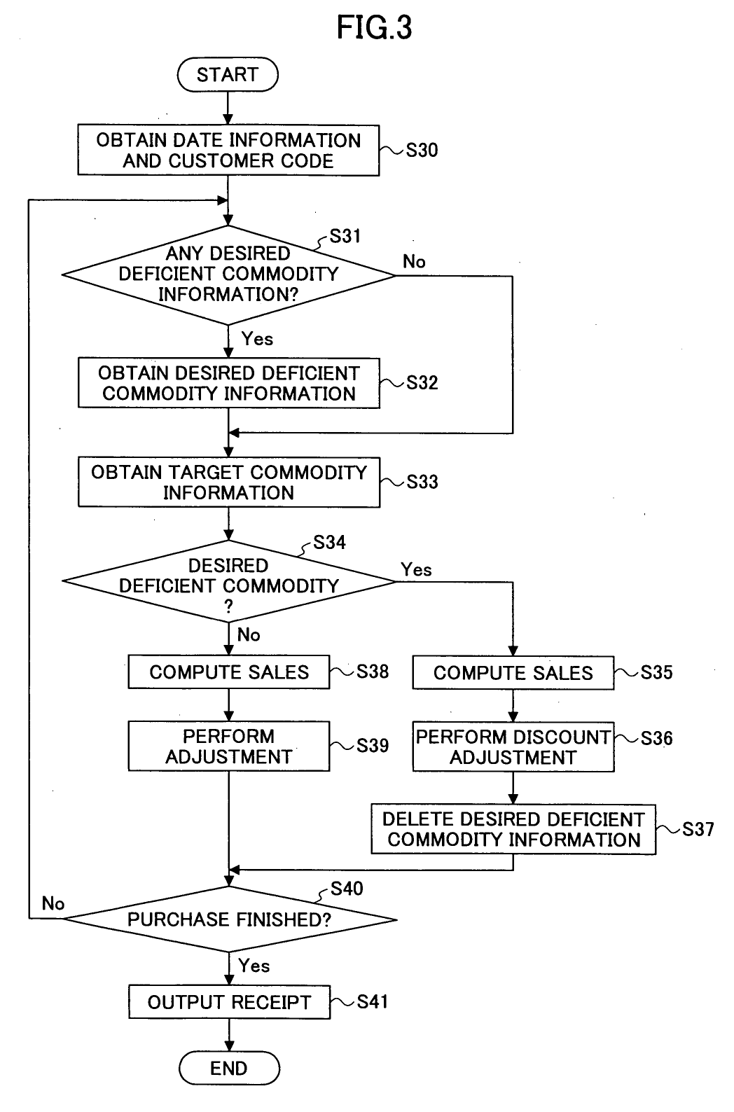

FIG. 4 shows a table 260 stored in the desired deficient commodity information DB 26. In FIG. 4, the table 260 includes, for example, customer codes, deficient commodity/purchased commodity codes, amount of commodities which are transmitted from the POS terminals 30, next time discount rate corresponding to the deficient commodity/purchased commodity, and the expiration date for applying the discount rate. More specifically, for example, in the first row in the table 260, the customer code is “001”, the desired deficient commodity code is “4910”, the the amount is “5”, discount rate for the next purchase is “10%”, and the expiration date of the discount rate is “02/02/10”.

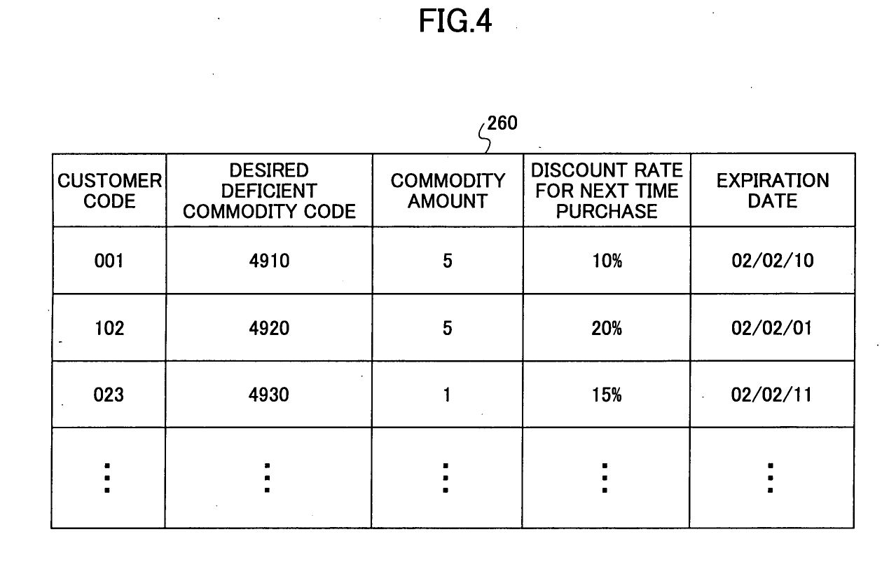

FIG. 5 shows a table 270 stored in the alternative commodity information DB 27. In FIG. 5, the table 270 includes, for example, commodity codes, commodity names corresponding to the commodity codes, alternative commodity codes, alternative commodity names corresponding to the alternative commodity codes, and the discount rate when purchasing the alternative commodity. More specifically, for example, in the first row in the table 270, the commodity code is “4910”, the commodity name is “beer A”, the alternative commodity code is “4911”, the alternative commodity name is “beer B”, and the discount point is “5%”.

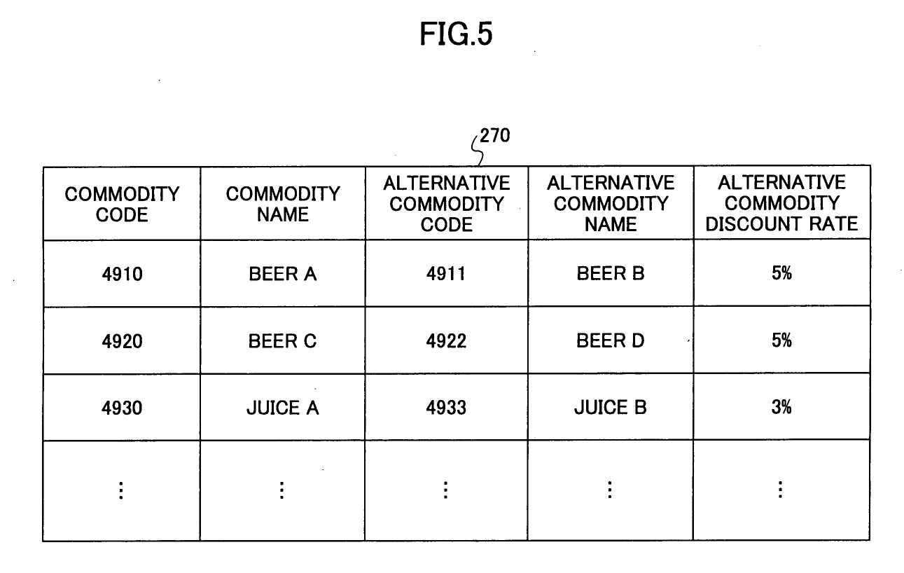

FIG. 6 shows a table 280 stored in the deficient commodity information DB 28. In FIG. 6, the table 280 includes, for example, deficient commodity codes, deficient commodity names corresponding to the deficient commodity codes, and the next arrival dates of the deficient commodity. More specifically, for example, in the first row in the table 280, the deficient commodity code is “4910”, the deficient commodity name is “beer A”, and the next arrival date is “02/02/10”.

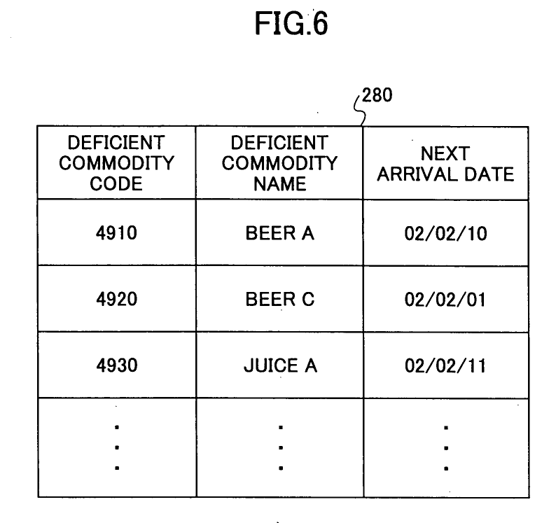

FIG. 7 shows a table 370 stored in the sales information DB 37. In FIG. 7, the table 370 includes, for example, purchase dates (representing when the commodity was purchased by the customer), commodity codes (representing the code of the purchased commodity), purchase amount (representing the amount of the purchased commodity), customer codes (representing the code of the customer purchasing the commodity), and discount rate (representing the discount rate applied during the next purchase). More specifically, for example, in the first row in the table 370, the purchase date is “02/01/25”, the commodity code is “4911”, the purchase amount is “5”, the customer code is “001”, and the discount rate is “5%”.

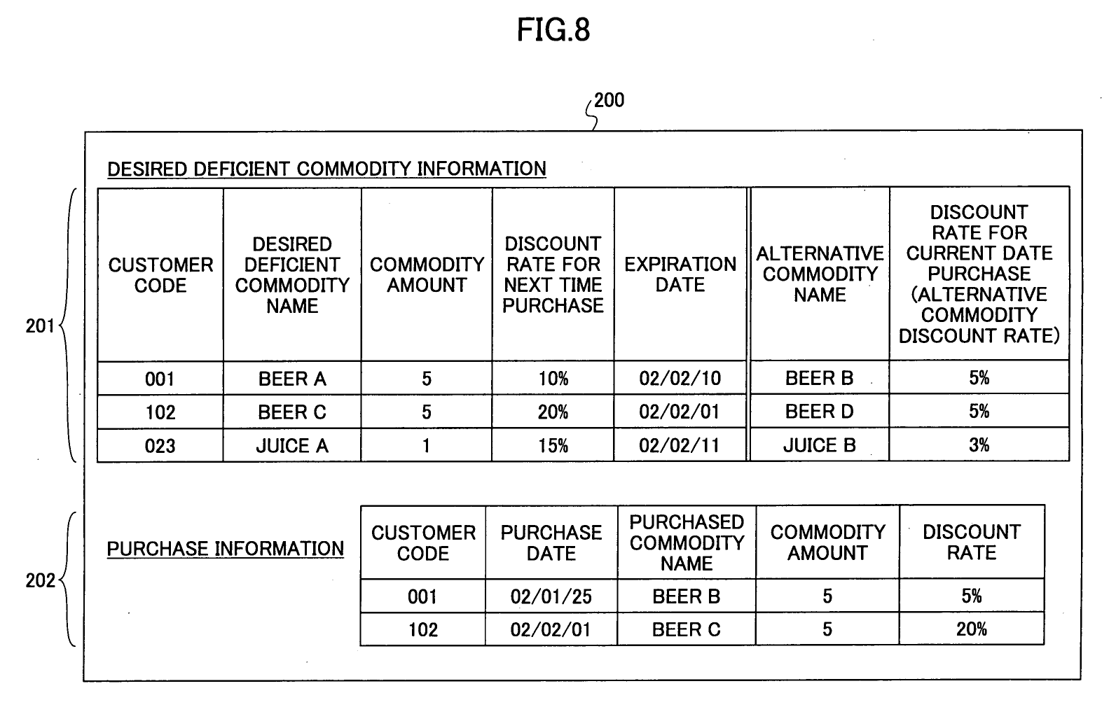

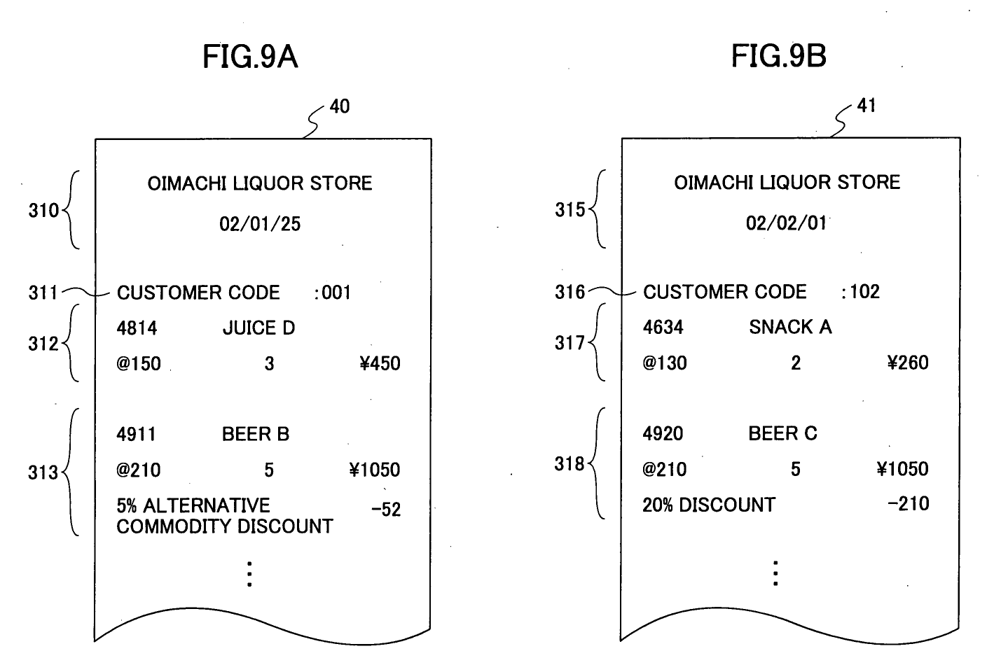

The POS terminal 30 with use of a bar code reader or the like reads out customer codes from a card with magnetic tape or with bar codes that have the customer codes registered therein. The read-out control part 32 controls the read out data. Likewise, the POS terminal 30 with use of the bar code reader or the like reads out commodity codes from a bar code attached to a commodity purchased by a customer or from a commodity tag, for example, for identifying a deficient commodity. According to the read-out customer codes and commodity codes, the sales computation part 35 and the adjustment part 36 compute the sales based on the desired deficient commodity information and/or alternative information from the store computer 20. The sales results are stores as sales information in the sales information DB 37. The sales results are displayed by a display unit (not shown) of the POS terminal 30. After the information for all of the purchased commodities are read out, the receipt output part 31 outputs a receipt of the sales results of the commodities. The receipt of the sales results is be described below in further detail with reference to FIGS. 9A and 9B.

Next, the procedure of a sales supporting method according to an embodiment of the present invention is described.

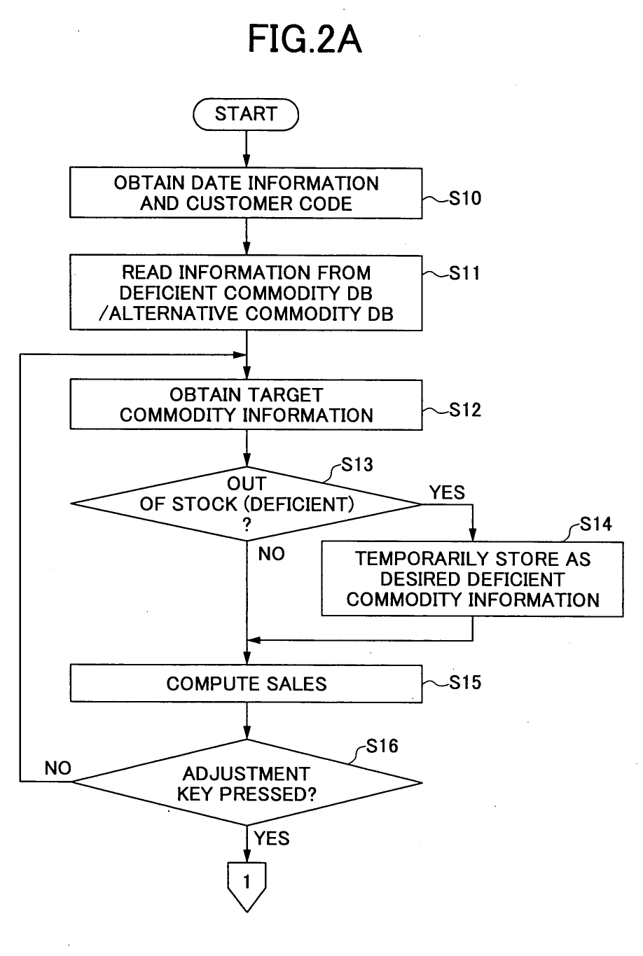

FIGS. 2A and 2B are flowcharts for explaining the sales supporting method according to an embodiment of the present invention. The flowcharts of FIGS. 2A and 2B show a sales support procedure in a case of a first time transaction. In this case, when a commodity desired by a customer is out of stock (deficient), the customer may receive a discount during the first time transaction by purchasing another commodity as an alternative for the desired commodity or the customer may make no purchase during the first time transaction but may receive a discount during a next time transaction by having information of the out of stock commodity (deficient commodity) registered during the first time transaction. In the case where the customer receives a discount for purchasing an alternative commodity, information of the desired deficient commodity is registered during the first time transaction.

In Step S10, date information and the customer code (through the read-out control part 32) are obtained from the POS terminal 30. In Step S11, the POS terminal 30 reads deficient commodity information stored in the deficient commodity DB 28, and alternative commodity information stored in the alternative commodity information DB 27 from the store computer 20.

Next, in Step S12, commodity information of a target commodity is obtained from the read-out control part 32. In Step S13, it is determined whether the commodity information obtained from the target commodity in Step S12 is deficient commodity information read out in Step S11.

When it is determined that the obtained commodity information is deficient commodity information (YES in Step S13), the commodity information of the target commodity is temporarily stored as desired deficient commodity information into a work area (not shown) in the POS terminal 30, in which the desired deficient commodity information is stored in correspondence with the customer code and a deficient commodity code (S14),

In Step S15, sales computation is performed in which the commodity information obtained in Step S12 is recorded. In Step S16, detection of whether an adjustment key (key for indicating adjustment of a purchased commodity and/or indicating completion of reading out commodity information) has been depressed is performed. When the depression of the adjustment key is detected (YES in Step S16), the process proceeds to Step S17 (see FIG. 2B). The process of obtaining commodity information is looped until the depression of the adjustment key is detected (NO in Step S16).

Then, the commodity information registered in Step S15 is read in Step S17. In Step S18, it is determined whether the read out commodity information matches the alternative commodity information read out in Step S11, and whether the commodity information includes deficient commodity information corresponding to the alternative commodity.

For example, when the read out (target) commodity information is “Beer B” having a commodity code of “4911”, it is determined that the target commodity information matches with the alternative commodity information. Then, it is further determined whether the read out target commodity information includes information of the initially desired deficient commodity information corresponding to the alternative commodity, in this case, whether “Beer A” (corresponding to alternative commodity “Beer B”) having a commodity code of “4910” is included in the target commodity information.

When it is determined that the target commodity information matches the alternative commodity information, and that the target commodity information includes the desired deficient commodity information (YES in Step S18), the procedure proceeds to Step S19. In Step S19, according to the foregoing example, “Beer B” is subjected to an adjustment (discount adjustment) based on the alternative commodity information. For example, with the alternative commodity information shown in FIG. 5, the value (price) of “Beer B” is discounted 5% from its net price, since the alternative commodity discount rate is 5%. In Step S20, the target commodity information (temporarily stored in Step S14) corresponding to the discounted commodity is deleted. Accordingly, in the foregoing example, information of the desired deficient commodity “Beer A” is deleted.

With the Steps S18 to S20, the alternative commodity purchased as an alternative for the desired commodity can be prevented from being repeatedly discounted.

When it is determined that the target commodity information does not match the alternative commodity information, and that the target commodity information does not include the desired deficient commodity information (NO in Step S18), the process proceeds to Step S21. In Step S21, a regular adjustment is performed based on data (e.g. commodity prices) stored in a commodity price DB (not shown).

In Step S22, it is determined whether adjustment of all commodities is finished. When the adjustment of the commodities is finished (YES in Step S22), a receipt is output in Step S23. In Step S24, remaining desired deficient commodity information that has been temporarily stored and not subjected to alternative discounting is stored in the desired deficient commodity information DB 26.

With the above-described procedures, providing information on deficient commodities and applying a discount rate based on the alternative commodity information DB 27 to a customer purchasing an alternative commodity, and displaying the deficient commodity information are performed.

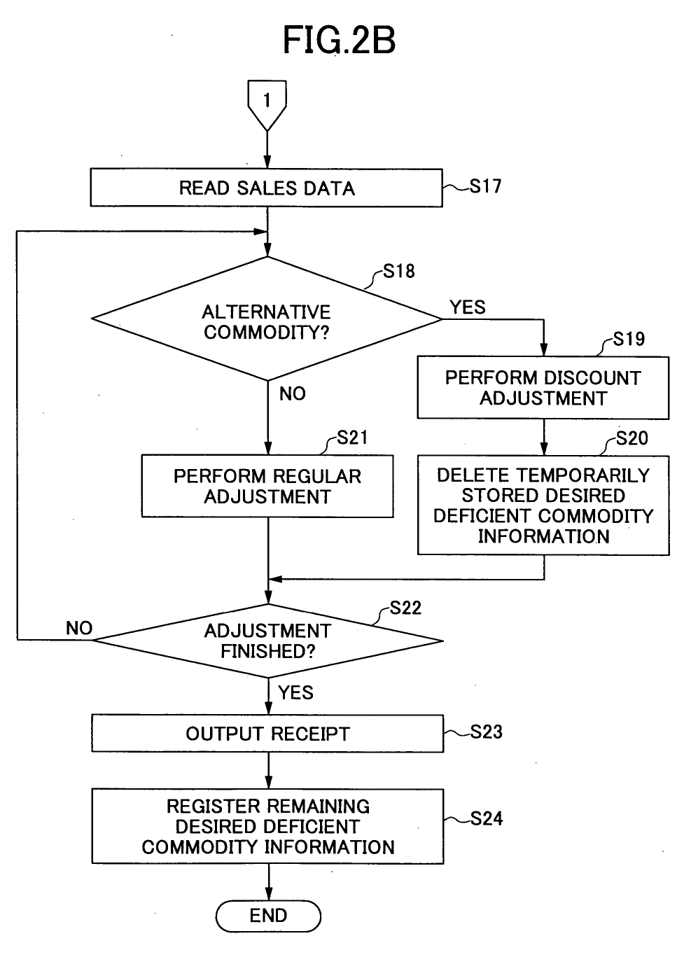

FIG. 3 is a flowchart for explaining the sales supporting method according to an embodiment of the present invention. The flowchart of FIG. 3 shows a sales support procedure in a case of a later (next) time purchase. In Step S30, date information and the customer code from the read-out control part 32 is obtained with the POS terminal 30. In Step S31, it is determined whether there is any registered desired deficient information corresponding to the customer code, which has not yet expired, in the desired deficient commodity information DB 26 of the store computer 20. When there is no registered desired deficient commodity information (NO in Step S31), the procedure proceeds to Step S33. When there is desired deficient commodity information (YES in Step S31), the desired deficient commodity information is obtained from the desired deficient commodity information DB 26 of the store computer 20 (Step 32).

Next, in Step S33, target commodity information is obtained with the read-out control part 32. In Step S34, it is determined whether the target commodity is a desired deficient commodity. When the target commodity is a desired deficient commodity (YES in Step S34), the sales computation part 35 performs a sales computation process for the target commodity (Step S35). Then, in Step S36, the adjustment part 36 performs a discount adjustment process for discounting the target commodity being the desired deficient commodity. In Step S37, the store computer 20, in response to a request from the POS terminal 30, deletes the desired deficient commodity information corresponding to the target commodity that has been discounted from the desired deficient commodity DB 26.

When the target commodity is not a desired deficient commodity (NO in Step S34), the sales computation part 35 performs a sales computation process for the target commodity (Step S38). Then, in Step S39, the adjustment part 36 performs an adjustment process. In Step S40, it is determined whether purchasing of all commodities is finished. When purchasing of the commodities is finished (YES in Step S40), the receipt output part 31 outputs a receipt indicative of sales computation and adjustment results (Step S41).

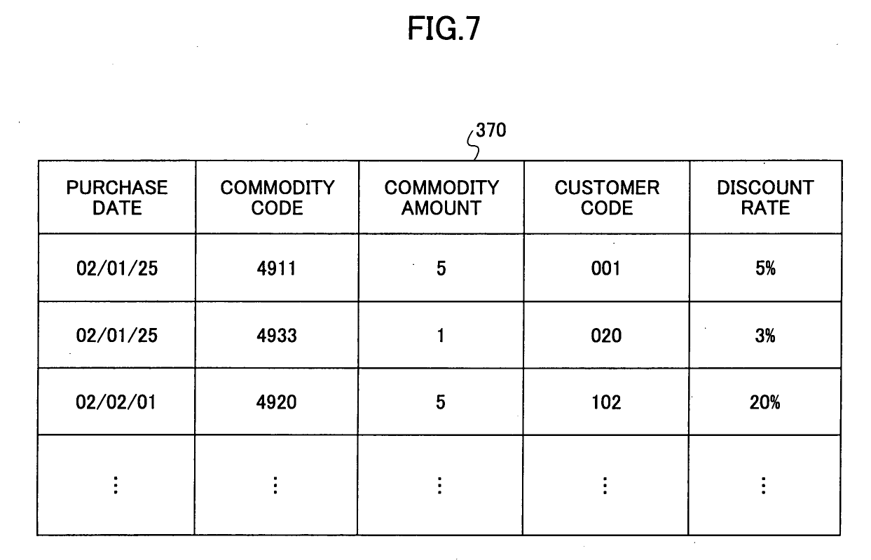

FIG. 8 is a schematic diagram showing an example of a display for explaining the sales supporting method according to an embodiment of the present invention. FIG. 8 shows a display 200 which is displayed by the store computer 20. The display 200 includes a display part 201 for displaying desired deficient commodity information and a display part 202 for displaying purchase information (sales information). The display part 201 displays, for example, customer codes of the customer having purchased the deficient commodity, names of the deficient commodities, purchased amount, discount rate for the next time purchase, expiration date, names of the alternative commodities, and discount rates for purchasing an alternative commodity on the current day instead of purchasing the desired deficient commodity in the next time (alternative commodity discount rate). More specifically, for example, according to the first row of the display part 201, the customer code is “001”, the name of the desired deficient commodity is “canned beer A”, the purchase amount is “5”, discount rate for the next time purchase is “10%”, the expiration date (for applying the discount rate for the next time purchase) is “02/02/10”, the alternative commodity is “canned beer B”, and the discount rate for the current day (discount rate for purchasing an alternative commodity instead of purchasing the desired deficient commodity on the next time) is “5%”. The display part 202 displays, for example, customer codes corresponding to the customer having purchased the desired deficient commodity, purchase dates, names of purchased commodities, purchased amount, and discount rates. More specifically, for example, according to the first row in the display part 202, the customer code is “001”, the purchase date is “02/01/25”, the name of the purchased commodity is “canned beer B”, the purchased amount is “5”, and the applied discount rate is “5%”.

FIGS. 9A and 9B are schematic diagrams showing a receipt output by a sales supporting method according to an embodiment of the present invention, in which FIG. 9A shows an example of a receipt output during the first time purchase of the sales supporting procedure according to an embodiment of the present invention (See FIGS. 2A and 2B), and FIG. 9B shows an example of a receipt output during the later time (next time) purchase of the sales supporting procedure according to an embodiment of the present invention. The receipt 40 of FIG. 9A includes, for example, a title part 310, a customer code part 311, and commodity information parts 312 and 313. More specifically, the title part 310 includes, for example, the name of the shop “OIMACHI LIQUOR SHOP”, and the purchase date “02/01/25”, and the customer code parts 311 includes, for example, the customer code “001”. Further, the commodity information part 312 includes, for example, the commodity code “4814”, the commodity name “JUICE D”, the unit price “@150”, the purchased amount “3”, and the total cost “450 yen”. Further, the commodity information part 313 includes, for example, the commodity code “4911”, the commodity name “BEER B”, the unit price “@210”, the purchased amount “5”, the total cost “1050 yen”, and the 5% discount for purchasing the deficient commodity during the first time purchase “−52 (yen)”.

The receipt 41 of FIG. 9B includes, for example, a title part 315, a customer code part 316, and commodity information parts 317 and 318. More specifically, the title part 315 includes, for example, the name of the shop “OIMACHI LIQUOR SHOP”, and the purchase date “02/02/01”, and the customer code parts 316 includes, for example, the customer code “102”. Further, the commodity information part 317 includes, for example, the commodity code “4634”, the commodity name “SNACK A”, the unit price “@130”, the purchased amount “2”, and the total cost “260 yen”. Further, the commodity information part 318 includes, for example, the commodity code “4920”, the commodity name “CANNED BEER C”, the unit price “@210”, the purchased amount “5”, the total cost “1050 yen”, and the 20% discount for purchasing the desired commodity during the first purchase “−210 (yen)”.

Accordingly, in a case where a desired commodity is out of stock, an alternative commodity corresponding to the desired out of stock commodity can be discounted. Further, in purchasing the out of stock commodity during the next time purchase, the commodity can be discounted. Hence, sales amounts of the store as well as customer satisfaction can be increased.

In addition, by outputting the receipts 40, 41 showing the discount results, the customer and operator of the POS terminal 30 can confirm, for example, the price of the discounted commodity or the discount rate. Further, by displaying the desired deficient commodity information and purchase information (sales information) on the display 200 of the store computer 20, the store manager can confirm the desired deficient commodity for the customer and/or the status of the desired deficient commodity.

Alternatively, in the sales supporting method (procedure) according to an embodiment of the present invention, the reservation commodity information and the purchase information displayed on the display 200 of the store computer 20 may also be displayed on the POS terminal 30.

Further, the present invention is not limited to these embodiments, but various variations and modifications may be made without departing from the scope of the present invention.

The present application is based on PCT Application No.02/03117 filed on Mar. 28, 2002, with the Japanese Patent Office, the entire contents of which are hereby incorporated by reference.

What is claimed is:

1. A method for supporting sales of a commodity to a customer, the method comprising the steps of:
a) managing desired deficient commodity information including information of a deficient commodity desired by the customer in correspondence with a first discount rate of the deficient commodity and identification information of the customer; and
b) discounting the desired deficient commodity based on the first discount rate in a case where the customer purchases the desired deficient commodity.

2. The sales supporting method as claimed in claim 1, further comprising a step of:
c) managing alternative commodity information including information of an alternative commodity corresponding to a prescribed commodity in correspondence with a second discount rate of the alternative commodity.

3. The sales supporting method as claimed in claim 2, further comprising a step of:
d) discounting the alternative commodity based on the second discount rate in a case where the customer purchases the alternative commodity.

4. The sales supporting method as claimed in claim 3, further comprising a step of:
e) outputting a receipt indicative of discount results according to at least one of the first discount rate and the second discount rate.

5. The sales supporting method as claimed in claim 4, further comprising a step of:
f) managing the at least one of the first discount rate and the second discount rate when discounting the commodity purchased by the customer.

6. The sales supporting method as claimed in claim 5, further comprising a step of:
g) deleting the desired deficient commodity information and the alternative commodity information.

7. The sales supporting method as claimed in claim 6, further comprising a step of:
h) displaying the desired deficient commodity information, the identification information, and the sales information.

8. A program for enabling a computer to execute a sales supporting method, the program comprising the functions of:
a) managing desired deficient commodity information including information of a deficient commodity desired by a customer in correspondence with a first discount rate of the deficient commodity and identification information of the customer; and
b) discounting the desired deficient commodity based on the first discount rate in a case where the customer purchases the desired deficient commodity.

9. A recording medium stored with a program for enabling a computer to execute the sales supporting method, the recording medium comprising:
the program as claimed in claim 8.
